(19) United States
(12) Patent Application Publication
(10) Pub. No.: US 2013/0083914 A1
(43) Pub. Date: Apr. 4, 2013

(54) TRANSFERRING A CALL FROM A FIRST FIXED COMMUNICATIONS TERMINAL IN A LOCAL NETWORK TO A SECOND FIXED COMMUNICATIONS TERMINAL IN THE SAME LOCAL NETWORK

(71) Applicants: Fabrice Fontaine, Geveze (FR); Philippe Duvivier, Romagne (FR); Herve Marchand, Vern Sur Seiche (FR)

(72) Inventors: Fabrice Fontaine, Geveze (FR); Philippe Duvivier, Romagne (FR); Herve Marchand, Vern Sur Seiche (FR)

(73) Assignee: FRANCE TELECOM, Paris (FR)

(21) Appl. No.: 13/697,255

(22) PCT Filed: May 5, 2011
(86) PCT No.: PCT/FR11/51018

§ 371 Date: Dec. 18, 2012

(30) Foreign Application Priority Data
May 11, 2010 (FR) 10 53700

(51) Int. Cl. H04M 3/58

(52) U.S. Cl. CPC H04M 3/58
USPC 379/212.01

(57) ABSTRACT

A method is provided for transferring an incoming call made to a first fixed communications terminal attached to a local network, towards a second fixed communications terminal forming part of a plurality of fixed communications terminals situated in the local network. The method includes: making comparisons between firstly data about the incoming call and secondly call data associated with the fixed communications terminals of the plurality of terminals as previously recorded in the local network; selecting, as the second fixed communications terminal, a favorite fixed communications terminal in application of a similarity criterion between the call data associated with that terminal and the data about the incoming call; and causing the incoming call to be transferred to the selected favorite fixed communications terminal.

### CROSS-REFERENCE TO RELATED APPLICATIONS

This application is a Section 371 National Stage Application of International Application No. PCT/FR2011/051018, filed May 5, 2011, which is incorporated by reference in its entirety and published as WO2011/141664 on Nov. 17, 2011, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure relates to the field of communications networks.

More precisely, the disclosure relates to transferring a call from a first fixed communications terminal situated in a local communications network to a second fixed communications terminal also situated in said local network.

### BACKGROUND

At present, certain telecommunications operators provide their subscribers with a call transfer service from their fixed telephones to another fixed terminal of their choice.

Such a service thus enables a user who needs to be absent from premises where the fixed communications line connected to the fixed telephone is installed to be able to receive incoming calls made to the usual fixed telephone, but using another fixed telephone situated in the premises and where said user is actually to be found.

A drawback of such a service lies in the fact that the user needs to provide the operator beforehand with the call number of a fixed telephone selected by the user. Thus, if the user changes number, the user needs to contact the operator once more in order to provide the new number that is to be used for call transfer as a replacement for the preceding number.

In addition, all incoming calls to the fixed telephone are transferred to a single fixed telephone having the call number that was previously supplied to the operator. As a result, it often happens that incoming calls are not necessarily of concern to the user of the fixed terminal having the number that has been registered with the call transfer service.

Another drawback lies in the fact that such a call transfer service requires the user to perform certain operations either to activate the service or else to deactivate it. For example, a user who has subscribed to the above-mentioned service must remember to activate the service before leaving home or the office in which the fixed telephone is installed, and likewise must remember to deactivate the service on returning home or to the office.

This drawback has the consequence of users frequently forgetting to activate or deactivate said service. Furthermore, in order to activate or deactivate such a service, the user needs to perform operations on keys and/or make selections in menus on the fixed telephone, with the end result of the call transfer service not being very ergonomic for the user.

Other call transfer solutions exist, that are more particularly adapted to business use.

A business generally has a telephone switchboard for transferring incoming calls that reach it to the fixed telephone of the employee concerned by the call. Such transfer is performed either manually, i.e. by an operator in charge of the telephone switchboard, or else automatically by using a voice menu.

A drawback of the “manual” call transfer technique lies in the fact that the call is often put on hold, for the time it takes the operator to make contact with the called employee, and that sometimes discourages callers who are particularly busy, and who hang up before being put through.

A drawback of the “automatic” call transfer technique lies in the fact that the caller is obliged to navigate in a menu before being able to speak with the called party, and that can also discourage the caller. In addition, such a menu generally serves to put the caller into communication with a person forming part of a particular service of the business (commercial service, accounts, after-sales service, etc. . . . ), such that the person reached is not necessarily the person with whom the caller really desires to communicate.

Another drawback of the two above-described solutions lies in the fact that the called party runs the risk of losing calls, either because the caller leaves a message on the called party's voice mail, which the called party then does not consult, or else because the caller transmits an oral message to the operator asking for the desired called party, which message the operator might forget to forward to the called party.

### SUMMARY

In a first aspect, an embodiment of the present invention provides a method of transferring an incoming call made to a first fixed communications terminal situated in a local network towards a second fixed communications terminal forming part of a plurality of fixed communications terminals situated in said local network.

Such a method is remarkable in that it comprises the following steps in the local network:
a comparison step of making comparisons between firstly the data about the incoming call and secondly the call data associated with the fixed communications terminals of said plurality of terminals as previously recorded in the local network;
a selection step of selecting, as the second fixed communications terminal, a favorite fixed communications terminal in application of a similarity criterion between the call data associated with that terminal and the data about the incoming call; and
a command step of causing said incoming call to be transferred to the selected favorite fixed communications terminal.

Such provisions thus enable an incoming call to be transferred automatically from one fixed telephone to another fixed telephone that belongs to the person considered to be the most concerned with the incoming call.

Thus, by way of example, when a client calls back to a remote assistance service or “hotline” in a business, an embodiment of the invention enables the client's call to be transferred to the fixed telephone of the person with whom the client has already been in contact during one or more earlier calls.

In addition, such a call transfer service no longer requires any configuration to be performed by users, i.e. the users do not need to provide a fixed terminal number in advance to the operator, nor do they need to activate/deactivate the service.

In one implementation, call data associated with the fixed communications terminals of the plurality of fixed terminals is recorded beforehand in response to a discovery request made to those terminals and transmitted over the local network.

Thus, within a given local network, such a provision enables a set of fixed communications terminals to be identified that might be selected during a subsequent transfer of an incoming call made to the first fixed telephone.

In one implementation, the above-mentioned discovery request is sent from a local terminal situated in the local network, such a request complying with a communications protocol appropriate for said local terminal and for said fixed communications terminals.

Such a provision makes it possible to take advantage of the transparent interoperability made available by the digital living network alliance (DLNA) standard between the various terminals connected to a local network, such as, in particular, firstly a local terminal such as a home or business gateway or indeed a digital decoder such as set-top-box, and secondly a plurality of fixed communications terminals present in the local network. To this end, each of the above-mentioned terminals has a module that operates for example using the universal plug and play (UPnP) protocol.

In another implementation, for a fixed communications terminal discovered in the local network, the call data associated therewith is selected from at least incoming call data, outgoing call data, and address book data of said discovered fixed communications terminal.

Such a provision thus makes it possible in the local network and on each occasion a fixed terminal is discovered therein, to recover either the incoming and/or outgoing calls or the address book or both the incoming and/or outgoing calls and the address book of the discovered fixed terminal. Such information as collected in this way for use subsequently during a call transfer, providing parameters for selecting the fixed terminal that is the most pertinent for the incoming call received by the first fixed terminal.

In yet another implementation, the comparison step comprises, for each discovered fixed communications terminal, determining the number of incoming/outgoing calls that correspond to the incoming call.

Thus, in a manner that is particularly simple and transparent for the user, the selection of the fixed terminal that is the most pertinent relative to the incoming call received by the first fixed communications terminal for use as the second fixed communications terminal is a function of the greatest number of occurrences of incoming/outgoing calls that appear in the call history of said second fixed terminal with the number that corresponds to the number of the incoming call.

In yet another implementation, the comparison step comprises, for each discovered fixed communications terminal, determining the presence of the number of the incoming call in the address book of said terminal.

Thus, in a manner that is likewise particularly simple and transparent for the user, selecting the fixed terminal that is the most pertinent relative to the incoming call received by the first fixed communications terminal as the second fixed communications terminal is a function of the presence of the number of the incoming call in the address book of one of the previously identified fixed terminals in the local network.

Such a provision may be performed as an alternative to the above provision.

Such a provision may also be performed in addition to the above provision, so as to refine the selection of the second fixed communications terminal to which the incoming call is to be redirected.

In yet another implementation, in the event of the transfer of the incoming call to the selected favorite fixed communications terminal failing, the incoming call is transferred to the first fixed communications terminal or to another fixed communications terminal selected from among the plurality of fixed terminals.

The call transfer system of an embodiment of the invention is thus made more user friendly for the caller, since the caller always has the possibility of being put into communication with a person.

In yet another implementation, the step of selecting the favorite fixed communications terminal and of causing the call to be transferred are configured beforehand by the user executing a man/machine interface program stored in a local terminal attached to the local network.

Thus, the above-mentioned configuration may be performed advantageously by the user using the above-mentioned gateway or set-top-box, given that these enable the above-mentioned man/machine interface to be executed.

Correspondingly, in a second aspect, an embodiment of the present invention provides a fixed communications terminal attached to a local network.

The fixed terminal of an embodiment of the invention comprises:
transmission means for transmitting a message in a communications protocol adapted to the fixed terminal over the local network and containing data about an incoming call received by the fixed terminal;
reception means for receiving a command in the above-mentioned communications protocol over the local network for transferring the incoming call to another fixed communications terminal selected in the local network; and
processor means for processing the received command to:
   extract the call number of the selected fixed communications terminal; and
   redirect the incoming call to the selected fixed communications terminal associated with the extracted call number.

In a third aspect, an embodiment of the present invention also provides a control device for transferring an incoming call made to a first fixed communications terminal situated in a local network towards a second fixed communications terminal forming part of a plurality of fixed communications terminals situated in the above-mentioned local network.

Such a device is remarkable in that it comprises:
comparator means comparing firstly the data about the incoming call and secondly call data associated with the fixed communications terminals of the plurality of fixed terminals and previously stored in the local network;
selection means for selecting as the second fixed communications terminal a favorite fixed communications terminal in application of a similarly criterion between the call data associated therewith and the data about the incoming call; and
control means for causing the incoming call to be transferred to the selected favorite fixed communications terminal.

Advantageously, such a control device may be embodied in a local terminal that can be controlled by the telecommunications operator, such as for example an interconnection device between the above-mentioned local network and an extended network, such as the Internet for example. In an embodiment, such an interconnection device is a domestic or business gateway.

In an embodiment, the call transfer control device further comprises memory means for previously storing call data associated with any fixed communications terminal situated in the local network.

In a fourth aspect, an embodiment of the present invention provides a system for transferring an incoming call made to a first fixed communications terminal situated in a local network towards a second fixed communications terminal forming part of a plurality of fixed communications terminals situated in the above-mentioned local network.

Such a system is remarkable in that:

the first fixed terminal includes transmission means for transmitting a message in a communications protocol adapted to the first fixed terminal via the local network, the message containing data about an incoming call received by the first fixed terminal; and in that

the incoming call transfer control device comprises:
reception means for receiving the transmitted message in the above-mentioned communications protocol;
comparison means for comparing firstly the data about the incoming call and secondly call data associated with the fixed communications terminals of the plurality of terminals and previously recorded in the local network;
selection means for selecting as the second fixed communications terminal a favorite fixed communications terminal in application of a similarity criterion between the call data associated therewith and the data about the incoming call; and
transmission means for transmitting a command in the above-mentioned communications protocol to the first fixed terminal for transferring the incoming call to the call number of the selected fixed communications terminal;

the fixed terminal further comprising:
reception means for receiving the transmitted transfer command using the above-mentioned communications protocol; and
processor means for processing the received command to:
   extract the call number of the selected fixed communications terminal; and
   redirect the incoming call to the selected fixed communications terminal associated with the extracted call number.

An embodiment of the invention also provides a computer program including instructions for executing steps of the above-mentioned call transfer method when the program is executed by a computer.

Such a program may use any programming language, and it may be in the form of source code, object code, or code intermediate between source code and object code, such as in a partially compiled form, or in any other desirable form.

An embodiment of the invention also provides a computer readable recording medium including instructions of a computer program as mentioned above.

The recording medium may be any entity or device capable of storing the program. For example, such a medium may comprise storage means such as a read only memory (ROM), for example a compact disk (CD) ROM or a microelectronic circuit ROM, or indeed magnetic recording means, e.g. a floppy disk or a hard disk.

Such a recording medium may also be a transmissible medium such as an electrical or optical signal, that may be conveyed via an electrical or optical cable, by radio, or by other means. The program of an embodiment of the invention may in particular be downloaded from an Internet type network.

Alternatively, such a recording medium may be an integrated circuit in which the program is incorporated, the circuit being adapted to execute the method in question or to be used in the execution thereof.

The above-mentioned fixed communications terminal, the call transfer control device, system, and computer program present at least the same advantages as the advantages conferred by the method of an embodiment of the present invention.

### BRIEF DESCRIPTION OF THE DRAWINGS

Other characteristics and advantages appear from the following description made with reference to the accompanying drawings that show an implementation having no limiting character. In the figures:

FIG. 1 shows the general architecture in which there is performed the call transfer method of one implementation of an embodiment of the invention;

FIG. 2 is a detailed diagram showing certain elements of the call transfer system of an embodiment of the invention;

FIG. 3 is a flow chart of the procedure for discovering the fixed communications terminals shown in FIG. 1;

FIG. 4 shows the contents of a database of the call transfer control device in an implementation; and

FIG. 5 is a flow chart of the call transfer method in accordance with an embodiment of the invention.

### DETAILED DESCRIPTION OF AN IMPLEMENTATION

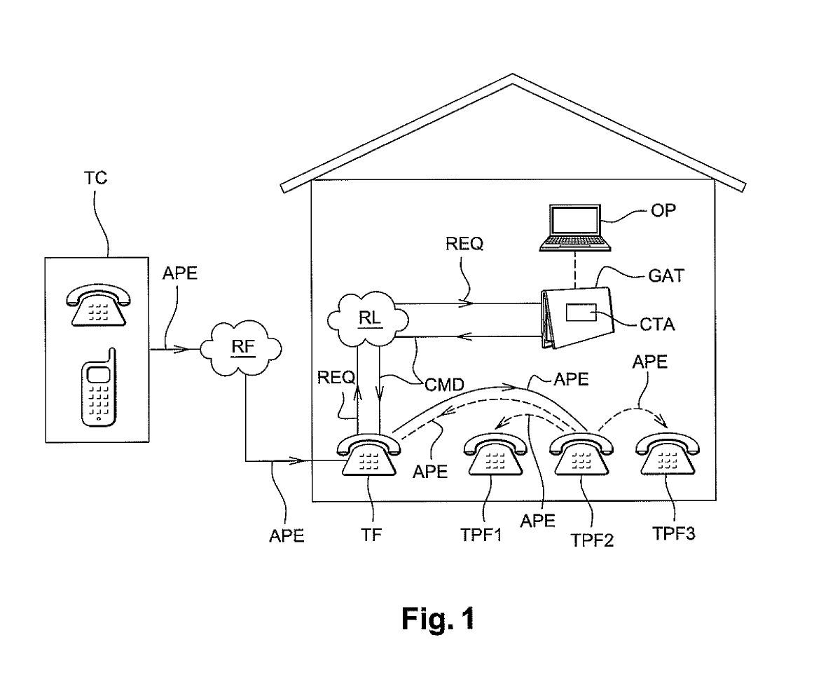

FIG. 1 is a general diagram of an embodiment of a call transfer system in which the call transfer method of the invention is performed.

In an embodiment of the invention, and in accordance with the example shown in FIG. 1, the call transfer system is situated in a local network RL that comprises:
a first fixed communications terminal TF connected to the local network RL and suitable for receiving telephone calls such as the call APE coming from a communications terminal TC that may be of fixed type or of mobile type (i.e. cellular or portable);
a call transfer control device CTA attached to the local network RL and adapted to transfer the incoming call APE to a second fixed communications terminal selected from a plurality of fixed communications terminals, e.g. three fixed communications terminals as shown in FIG. 1 and referenced TPF1, TPF2, and TPF3.

In the example shown, the fixed terminals TF, TPF1, TPF2, and TPF3 are adapted to operate in a fixed communications network RF such as a fixed telephone network, e.g. the public switched telephone network (PSTN).

To this end, each of said fixed terminals is constituted, for example, by a telephone that is either connected to the fixed network RF by a wired connection, or else via a connection using a cordless communications protocol, e.g. the digital enhanced cordless telecommunications (DECT) protocol.

The fixed telephone network in this example is coupled to the local network RL in entirely conventional manner.

In the example shown and by way of example, the local network RL is an Ethernet network making use of the WiFi wireless connection protocol.

The local network RL may equally well be a home network or a business local network, and it may be constituted in part or in full by wireless segments.

More particularly, in the example shown, the local network RL is of the business type (e.g. an Intranet). For this purpose, the first fixed communications terminal TF is constituted by a conventional private telephone switchboard and the fixed communications terminal TPF1, TPF2, and TPF3 are associated respectively with three distinct people in the business, who might all belong to the same service, but they need not.

In an embodiment of the invention, the call transfer control device CTA is installed in a local terminal situated in the local network RL.

In the implementation shown, the local terminal is an interconnection device GAT, in particular such as a business gateway, suitable for interconnecting the local network RL with an extended network of the Internet type (not shown).

In a variant, the local terminal may be a set-top-box.

As an alternative, it should be observed that the first fixed terminal TF and the device CTA could form part of a single piece of equipment.

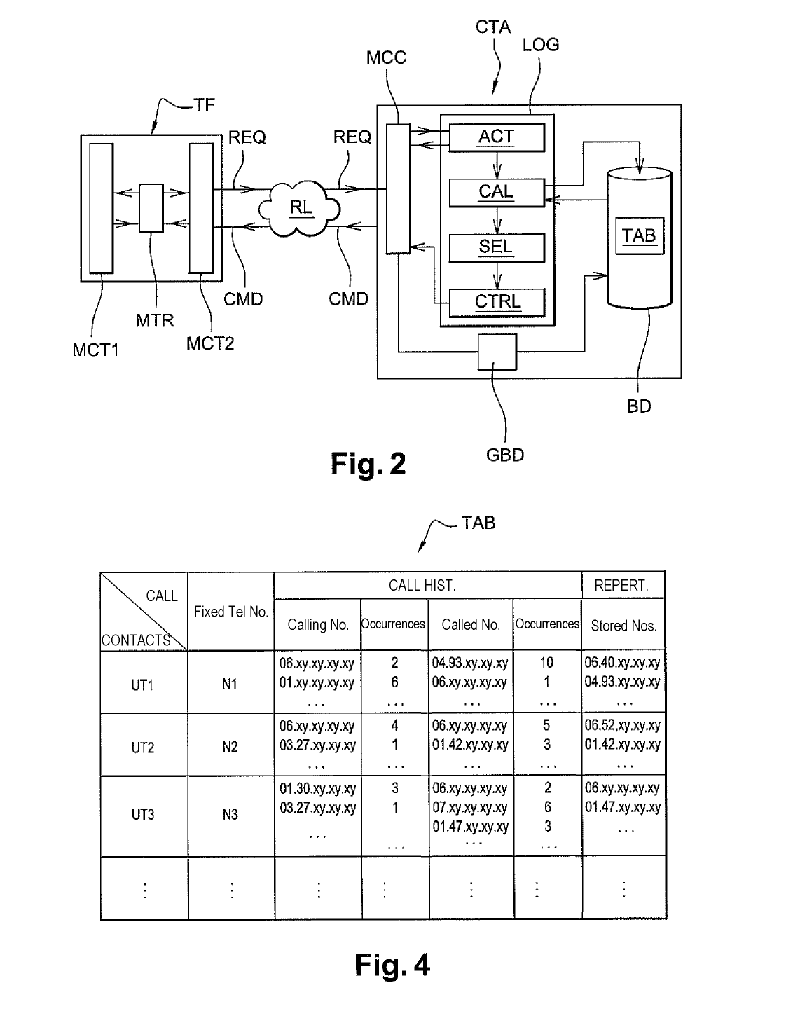

With reference to FIG. 2, the first fixed terminal TF conventionally includes a first communications module MCT1 suitable for sending and receiving telephone calls via the fixed communications network RF.

In an embodiment of the invention, the first fixed terminal TF also includes a second communications module MCT2 that is suitable for:
transmitting a message REQ to the call transfer control device CTA over the network RL while using a communications protocol that is compatible with the control device CTA, the message REQ containing data about the incoming call APE, such as the telephone number of the calling terminal TC (as shown in FIG. 1); and
receiving in response, using said communications protocol, a command CMD from the call transfer control device CTA for transferring said incoming call to one of the fixed terminals TPF1, TPF2, or TPF3 previously selected by a method that is described below, e.g. the terminal TPF2 (shown in FIG. 1).

In the example shown in FIG. 2, the communications module MCT2 is a software module suitable for performing a signaling protocol, such as a telephony server module operating in application of the UPnP telephony protocol.

Still with reference to FIG. 2, the first fixed terminal TF includes a processor module MTR to which all of the elements of the first fixed terminal TF are connected and that serves to control the operation of the terminal. Said processor module includes software stored in a ROM (not shown) of the first fixed terminal TF.

Such a processor module MTR is adapted in particular to:
control the telephony module MCT1 on receiving an incoming call APE;
control the UPnP software module MCT2, in particular when the first fixed terminal TF is sending a message REQ containing data about the incoming call APE, and when the fixed terminal TF is receiving a command CMD for transferring said incoming call;
extract from the received command CMD, the call number of the fixed communications terminal TPF2 that has been selected to receive the incoming call APE; and
redirect the incoming call APE to said selected fixed terminal TPF2 having the call number that corresponds to the extracted call number.

In a manner analogous to the first fixed terminal TF, the call transfer control device CTA includes a communications module MCC that is adapted to:
receive said message REQ containing the data about the incoming call APE from the first fixed terminal TF over the local network RL using the above-mentioned communications protocol; and
send in response said command CMD to the first fixed terminal TF over the local network RL and using the same communications protocol, in order to cause the incoming call to be transferred.

For this purpose, in the example shown in FIG. 2, the communications module MCC is a software module suitable for performing the UPnP telephony signaling protocol.

In an embodiment of the invention, the call transfer control device CTA also includes a detection module suitable for determining whether or not the fixed terminals TPF1, TPF2, or TPF3 are connected to the local network RL.

In the example shown in FIG. 2, such a detection module advantageously consists in the UPnP telephony module MCC that is conventionally configured to use the UPnP telephony protocol over the local network to discover and control any terminal that might be connected to the local network, and in particular the fixed terminals TPF1, TPF2, and TPF3.

In the above-described embodiment, the module MCC consists more precisely in a UPnP telephony control unit. Furthermore, such a configuration requires the fixed terminals TPF1, TPF2, and TPF3 to have respective communications modules (not shown) that also operate in application of the UPnP telephony protocol, such as in particular, respective telephony server modules.

According to an embodiment of the invention, the call transfer control device CTA also includes a database BD stored in a memory (not shown) of the device and serving by means of a database manager GBD to store in association with each discovered fixed communications terminal certain characteristics that are specific to that discovered fixed terminal, such as in particular:
its call number;
the history of its incoming and/or outgoing calls; and
the data of its telephone address book.

In the example shown, the above-mentioned characteristics are stored in the database BD in the form of an extended mark-up language (XML) file.

Still with reference to FIG. 2, the call transfer control device CTA also includes, according to an embodiment of the invention, a processor software module, referenced LOG, that is stored in a ROM (not shown) of the device CTA.

The processor module LOG comprises in particular:
an activation module ACT suitable, on each incoming call APE identified in the message REQ received by the detection module MCC, for operating the “discovery” function of said module in order to detect actual connection in the local network of at least one fixed terminal selected from the plurality of fixed terminals TPF1, TPF2, and TPF3;
a calculation module CAL that is activated when such an actual connection has been detected, said module CAL being suitable for comparing the data about the incoming call APE with the call data associated with each fixed terminal TPF1, TPF2, and TPF3 connected to the local network RL as previously stored in the database BD during the above-mentioned discovery stage, and also during any earlier discovery stages;
a selection module SEL for selecting a favorite fixed communications terminal from among the fixed terminals TPF1, TPF2, and TPF3 to constitute the second fixed communications terminal to which the incoming call APE is to be redirected, the selection being made on the basis of a criterion concerning similarity between the call data associated with that terminal and the data about the incoming call APE; and
a control module CTRL for controlling the detection module MCC so that it sends said command CMD over the local network RL to the first fixed terminal TF in order to transfer said incoming call APE.

With reference now to FIGS. 1 to 3, there follows a description of the procedure for discovering the fixed terminals TPF1, TPF2, and TPF3, which procedure is performed prior to transferring a call in accordance with an embodiment of the invention.

In the example shown in FIG. 1, it is assumed that all three fixed terminals TPF1, TPF2, and TPF3 are connected to the local network RL.

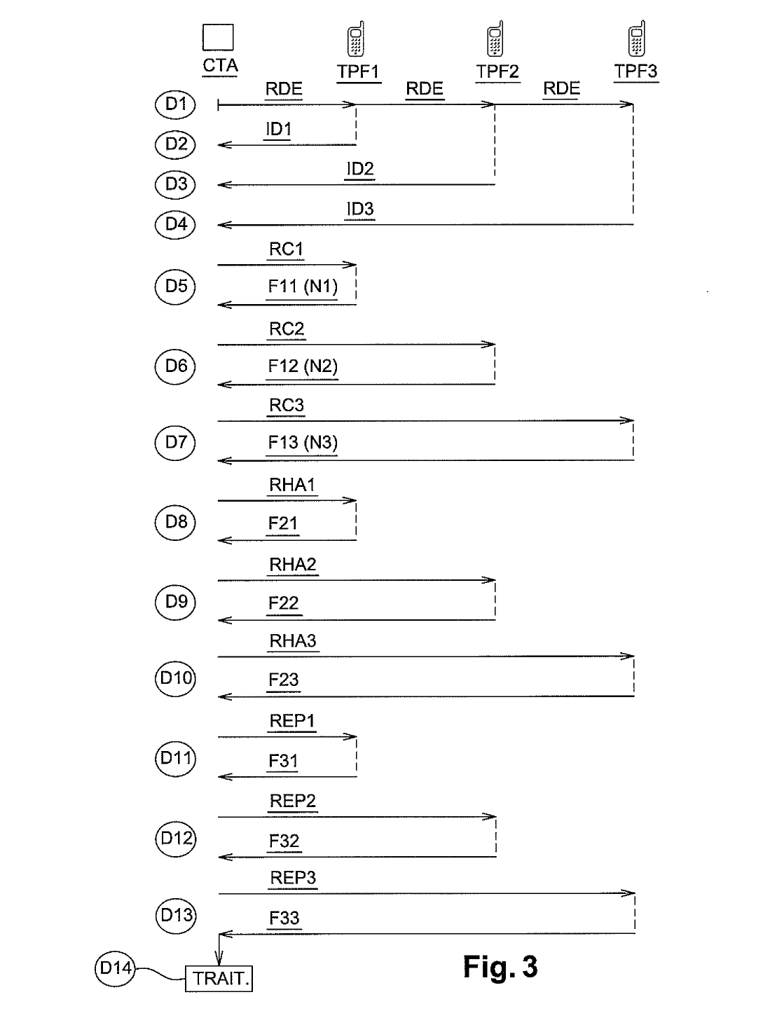

More precisely, with reference to FIG. 3, during a step D1, the communications module MCC of the call transfer control device CTA uses the UPnP telephony protocol to send a discovery request RDE to the respective telephony server modules of the fixed terminal TPF1, of the fixed terminal TPF2, and of the fixed terminal TPF3.

In the example shown, such a discovery request is of the multicast simple service discovery protocol (SSDP) type and is written:
“SSDP M-SEARCH urn:schemas-upnp-org:device:TelephonyServer:1”

During a step D2, the telephony server module of the fixed terminal TPF1 sends a UPnP response ID1 to the communications module MCC of the device CTA, the response containing an identifier of the fixed terminal TPF1.

In the example shown, the response ID1 contains a link url1 to be accessed by the device CTA in order to recover the identifier of the fixed terminal TPF1. The response ID1 is written: “HTTP 200 OK LOCATION: url1”.

During a step D3, the telephony server module of the fixed terminal TPF2 sends a UPnP response ID2 to the communications module MCC of the device CTA, which response contains an identifier of the fixed terminal TPF2.

In the example shown, the response ID2 contains a link url2 to be accessed by the device CTA in order to recover the identifier of the fixed terminal TPF2. The response ID2 is written: “HTTP 200 OK LOCATION: url2”.

During a step D4, the telephony server module of the fixed terminal TPF3 sends a UPnP response ID3 to the communications module MCC of the device CTA, the response containing an identifier of the fixed terminal TPF3.

In the example shown, the response ID3 contains a link url3 to be accessed by the device CTA in order to recover the identifier of the fixed terminal TPF3. The response ID3 is written: “HTTP 200 OK LOCATION: url3”.

The above-mentioned steps D2, D3, and D4 may take place simultaneously or one after another, in any order.

During a step D5, the device CTA sends a connection request RC1 to the url1 via a browser (not shown) such as for example the browser of the home gateway GAT in which the control device CTA is installed. The request RC1 is written: “HTTP GET url1”.

During this step, the telephony server module of the fixed terminal TPF1 sends in response to the device CTA a description file F11 of the XML type and in which a “friendlyName” parameter contains the call number N1 of the fixed terminal TPF1.

During a step D6, the device CTA sends a connection request RC2 to the url2. The request RC2 is written: “HTTP GET url2”.

During this step, the telephony server module of the fixed terminal TPF2 sends in response to the device CTA a description file F12 of the XML type and in which the friendlyName parameter contains the call number N2 of the fixed terminal TPF2.

During a step D7, the device CTA sends a connection request RC3 to the url3. The request RC3 is written: “HTTP GET url3”.

During this step, the telephony server module of the fixed terminal TPF3 sends in response to the device CTA a description file F13 of the XML type and in which the friendlyName parameter contains the call number N3 of the fixed terminal TPF3.

During a step D8, the communications module MCC of the device CTA sends a UPnP type request RHA1 to the telephony server module of the fixed terminal TPF1 in order to recover the call history of that fixed terminal.

The request RHA1 is written “Action UPnP GetCallLogs”.

During this step, the telephony server module of the fixed terminal TPF1 sends in response to the communications module MCC of the device CTA a description file F21 of the XML type and containing in particular the time of each incoming and/or outgoing call associated with the fixed terminal TPF1, together with the calling and/or called numbers.

In a variant, step D8 may be performed directly after above-mentioned step D5.

During step D9, the communications module MCC of the device CTA sends a UPnP type request RHA2 to the telephony server module of the fixed terminal TPF2 in order to recover the call history for said fixed terminal.

The request RHA2 is written in the same manner as the above request RHA1.

During this step, the telephony server module of the fixed terminal TPF2 responds to the communications module MCC of the device CTA by sending a description file F22 of the XML type and containing in particular the time of each incoming and/or outgoing call associated with the fixed terminal TPF2, together with the calling and/or called numbers.

In a variant, step D9 may be performed directly after above-mentioned step D6.

During a step D10, the communications module MCC of the device CTA sends a UPnP type request RHA3 to the telephony server module of the fixed terminal TPF3 in order to recover the call history of said fixed terminal.

The request RHA3 is written in the same manner as the above request RHA1 and RHA2.

During this step, the telephony server module of the fixed terminal TPF3 responds to the communications module MCC of the device CTA by sending a description file F23 of the XML type and containing in particular the time of each incoming and/or outgoing call associated with the fixed terminal TPF3, together with the calling and/or called numbers.

In a variant, the step D10 may be performed directly after above-mentioned step D7.

During a step D11, the communications module MCC of the device CTA sends a UPnP type request REP1 to the telephony server module of the fixed terminal TPF1 in order to recover the telephone address book of said fixed terminal.

The request REP1 is written:
“Action UPnP GetValues/UPnP/PHONE/AddressBook/Contact/”.

During this step, the telephony server module of the fixed terminal TPF1 responds to the communications module MCC of the device CTA by sending a description file F31 of the XML type and containing in particular the fixed and/or mobile call numbers of each contact entered in the telephone address book of the fixed terminal TPF1.

In a variant, the step D11 may be performed directly after above-mentioned step D8.

During a step D12, the communications module MCC of the device CTA sends a UPnP type request REP2 to the telephony server module of the fixed terminal TPF2 in order to recover the telephone address book of said fixed terminal.

The request REP2 is written in the same manner as the above-mentioned request REP1.

During this step, the fixed terminal TPF2 responds to the communications module MCC of the device CTA by sending a description file F32 of the XML type and containing in particular the fixed and/or mobile call numbers of each contact recorded in the telephone address book of the fixed terminal TPF2.

In a variant, the step D12 may be performed directly after the above-mentioned step D9.

During a step D13, the communications module MCC of the device CTA sends a UPnP type request REP3 to the telephony server module of the fixed terminal TPF3 in order to recover the telephone address book of said fixed terminal.

The request REP3 is written in the same manner as the above-mentioned requests REP1 and REP2.

During this step, the fixed terminal TPF3 responds to the communications module MCC of the device CTA by sending a description file F33 of the XML type and containing in particular the fixed and/or mobile call numbers of each of the contacts entered in the telephone address book of the fixed terminal TPF3.

In a variant, the step D13 may be implemented directly after the above-mentioned step D10.

During a step D14, the database manager GBD shown in FIG. 2 processes the storing in the database BD of the information received by the device CTA during above-mentioned steps D1 to D13.

With reference to FIG. 4, the database BD contains for this purpose a double-entry table TAB comprising in the row direction, data concerning a call, and in the column direction data concerning the users of the fixed terminals TPF1, TPF2, and TPF3.

In the example shown, it is assumed that the fixed terminals TPF1 and TPF2 belong respectively to two distinct people UT1 and UT2 who are both in the same service, e.g. the hotline service of the business in which the local network RL is installed, while the fixed terminal TPF3 belongs to a person UT3 who is in another service of the business, e.g. the commercial service, for example.

Each user UT1, UT2, and UT3 is associated in the table TAB with the respective number N1, N2, N3 of the corresponding fixed terminal TPF1, TPF2, TPF3, the history of the corresponding incoming/outgoing calls, and the telephone numbers in the telephone address book.

The heading CALL.HIST comprises the following sub-headings: the number associated with each incoming call;
the number of occurrences of a given incoming call;
the number associated with each outgoing call; and
the number of occurrences of a given outgoing call.

The steps D1 to D14 are repeated several times over in time, preferably at regular time intervals (e.g. every six hours) as previously configured in the control device CTA.

Thus, the database BD may be updated as often as needed.

Given that in the example shown in FIG. 1, the control device CTA is installed in a gateway GAT, each user may be informed about the information collected in the table TAB during the above-mentioned steps D1 to D14 by using a terminal connected to the gateway GAT in the local network RL. In the example described, the terminal is a laptop computer OP. In another example, such a terminal may be a mobile terminal of the user UT1, UT2, or UT3. When the control device CTA is installed in a set-top-box, the terminal may be a television receiver.

Advantageously, the gateway GAT thus gives the user a man/machine interface viewable on the screen of the laptop computer OP, thereby enabling the user to modify the configuration of the table TAB.

Thus, by example, the user may cancel automatic call transfer for certain times, or personally modify the number of a terminal to which such a call transfer should be made.

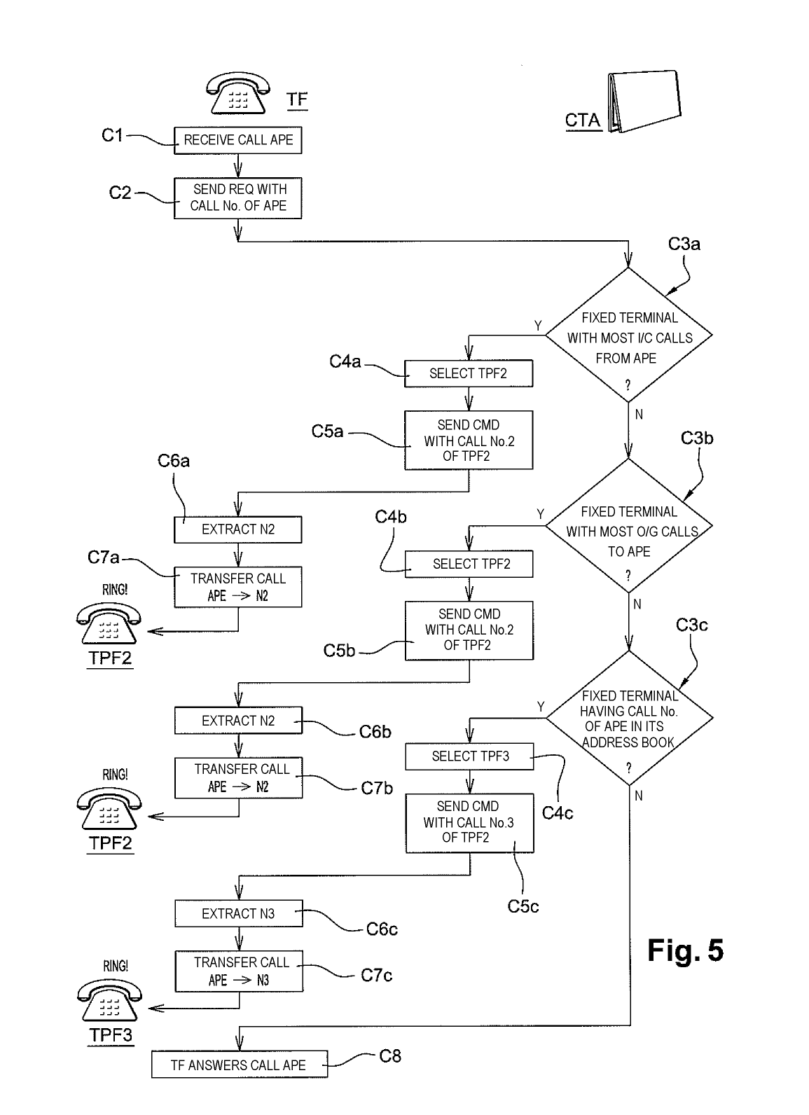

With reference more particularly to FIGS. 2 and 5, there follows a description of the method of transferring a call in accordance with an embodiment of the invention.

In a step C1, the telephony module MCT1 of the fixed terminal TF, shown in FIG. 2, receives a incoming call APE via the fixed communications network RF.

In the example shown, the number corresponding to the incoming call is for example the number 06.xy.xy.xy.xy stored in the table TAB of FIG. 4.

In a step C2, the processor module MTR of the fixed terminal TF operates the UPnP module MCT2 thereof so that the fixed terminal TF sends a message REQ containing data about the incoming call APE to the control device CTA.

During a step C3a, the module CAL of the control device CTA makes use of the table TAB previously stored in the database BD to determine which one of the fixed terminals TPF1, TPF2, TPF3 presents the greatest number of incoming calls for which the number corresponds to the number of the call APE, i.e. 06.xy.xy.xy.xy. From the table TAB, this is the fixed terminal TPF2 of the user UT2.

During a step C4a, the module SEL of the control device CTA selects the fixed terminal TPF2 as the favorite fixed terminal to which the call APE should be transferred and transmits the call number N2 associated with the fixed terminal TPF2 to the control module CTRL of the control device CTA.

During a step C5a, the module CTRL of the control device CTA activates its UPnP module MCC to cause it to send a UPnP command CMD for transferring said incoming call APE to the UPnP module MCT2 of the fixed terminal TF over the local network RL, said command CMD containing the call number N2 of the fixed terminal TPF2.

During a step C6a, the processor module MTR of the fixed terminal TF extracts from the received command CMD the call number N2 of the fixed communications terminal TPF2 that has been selected to receive the incoming call APE.

During a step C7a, the processor module MTR causes the telephony module MCT1 of the fixed terminal TF to redirect the incoming call APE to said selected fixed terminal TPF2 on the basis of its call number N2.

After a certain number of rings, e.g. four, if the fixed terminal TPF2 has not been answered, the steps C3a to C7a are repeated, once the module CAL of the control device CTA has used the table TAB of FIG. 4 once more to determine which one of the fixed terminals TPF2 and TPF3 presents the greatest number of incoming calls having the call number corresponding to the number of the call APE, i.e. 06.xy.xy.xy.xy. From table TAB, this is the fixed terminal TPF1 of the user UT1 and the incoming call APE is thus transferred thereto at the end of step C7a, as shown in dotted lines in FIG. 1.

Alternatively, on repeating steps C3a to C7a, the incoming call APE may be transferred to the first fixed terminal TF, specifically the switchboard of the business.

Such an arrangement thus serves to optimize call transfer by selecting another fixed terminal when the selected favorite fixed terminal does not answer the incoming call redirected thereto or when the redirection of the incoming call to the favorite fixed terminal does not succeed. In particular, in the implementation shown, the caller, who may for example be a client of the business in which the users UT1, UT2, and UT3 work, has the possibility, if the call to the user UT2 does not succeed, of being received at least by the user UT1 who, as another worker in the same service as the user UT2, will be the person best placed to answer the client's questions.

If during the above-mentioned step C3a, the module CAL of the control device CTA is not in a position to use the table TAB and determine which one of the fixed terminals TPF1, TPF2, and TPF3 presents the greatest number of incoming calls with the call number corresponding to the number of the call APE, i.e. 06.xy.xy.xy.xy, then, during a step C3b, the module CAL uses the table TAB to determine which fixed terminal TPF1, TPF2, or TPF3 presents the greatest number of outgoing calls to the number that corresponds to the number of the call APE, i.e. 06.xy.xy.xy.xy. From the table TAB, this is still the fixed terminal TPF2 of the user UT2.

During a step C4b the module SEL of the control device CTA selects the fixed terminal TPF2 as the favorite fixed terminal to which the call APE should be transferred and it transmits the call number N2 associated with the fixed terminal TPF2 to the control module CTRL of the control device CTA.

During a step C5b, the module CTRL of the control device CTA activates its UPnP module MCC to send a UPnP command CMD to the UPnP module MCT2 of the fixed terminal TF over the local network RL in order to transfer said incoming call APE, said command CMD containing the call number N2 of the fixed terminal TPF2.

During a step C6b, the processor module MTR of the fixed terminal TF extracts from the received command CMD the call number N2 of the fixed terminal TPF2 that has been selected to receive the incoming call APE.

During a step C7b, the processor module MTR operates the telephony module MCT1 of the fixed terminal TF so as to cause it to redirect the incoming call APE to said selected fixed terminal TPF2 on the basis of its call number N2.

If the fixed telephone TPF2 is not answered, the call is transferred either to one of the fixed telephones TPF1, TPF3 after repeating steps C3b to C7b, or else to the telephone switchboard TF, as explained above.

If during the above-mentioned step C3b, the module CAL of the control device CTA cannot use the table TAB to determine which one of the fixed terminals TPF1, TPF2, TPF3 has the greatest number of outgoing calls with the call number corresponding to the number of the call APE, i.e. 06.xy.xy.xy.xy, then during a step C3c, the module CAL of the control device CTA uses the table TAB to determine which one of the fixed terminals TPF1, TPF2, or TPF3 contains the number of the call APE in its address book. From the table TAB, this is the fixed terminal TPF3 of the user UT3, who is part of the commercial service.

During a step C4c, the module SEL of the control device CTA selects the fixed terminal TPF3 as the favorite fixed terminal to which the call APE should be transferred and sends the call number N3 associated with the fixed terminal TPF3 to the control module CTRL of the control device CTA.

During a step C5c, the module CTRL of the control device CTA activates its UPnP module MCC to cause it to send a UPnP command CMD to the UPnP module MCT2 of the fixed terminal TF via the local network RL in order to transfer said incoming call APE, said command CMD containing the call number N3 of the fixed terminal TPF3.

During a step C6c, the processor module MTR of the fixed terminal TF extracts from the received command CMD the call number N3 of the fixed terminal TPF3 that has been selected to receive the incoming call APE.

During a step C7c, the processor module MTR operates the telephony module MCT1 of the fixed terminal TF to cause it to redirect the incoming call APE to the selected fixed terminal TPF3 on the basis of its call number N3.

If the fixed telephone TPF3 is not answered, the call is transferred either to one of the other fixed telephones TPF1, TPF2 after reiterating the steps C3c to C7c, or else to the telephone switchboard TF, as explained above.

If during the above-mentioned step C3c, the module CAL of the control device CTA cannot use the table TAB to determine which one of the fixed terminals TPF1, TPF2, and TPF3 contains the number of the call APE in its address book, then the telephone switchboard TF answers the call APE directly during a step C8.

It should be observed that the steps C3a to C7a, C3b to C7b, C3c to C7c may be performed in an order other than that described above. For example, the steps C3c to C7c could be performed before the steps C3a to C7a.

Naturally, the above-described implementation is given purely by way of non-limiting indication and numerous modifications may easily be provided by the person skilled in the art without thereby going beyond the ambit of the invention.

1. A method of transferring an incoming call made to a first fixed communications terminal situated in a local network, towards a second fixed communications terminal forming part of a plurality of fixed communications terminals situated in said local network, said method comprising the following steps in the local network:
a comparison step of making comparisons between firstly data about the incoming call and secondly call data associated with said fixed communications terminals of said plurality of terminals and previously recorded in the local network, said call data associated with the fixed communications terminals of the plurality of fixed communications terminals being recorded beforehand in response to a discovery request made to those terminals and transmitted over the local network, said discovery request being sent from a local terminal situated in the local network, said request complying with a communications protocol appropriate for said local terminal and for said fixed communications terminals;
a selection step of selecting, as the second fixed communications terminal, a favorite fixed communications terminal in application of a similarity criterion between the call data associated with that terminal and the data about the incoming call, said call data associated therewith being selected from at least incoming call data, outgoing call data, and address book data of said discovered fixed communications terminal; and
a command step of causing said incoming call to be transferred to the selected favorite fixed communications terminal.

2. (canceled)

3. (canceled)

4. (canceled)

5. The method according to claim 1, wherein the comparison step comprises determining, for each discovered fixed communications terminal, the number of incoming/outgoing calls that correspond to said incoming call.

6. The method according to claim 1, in which the comparison step comprises, for each discovered fixed communications terminal, determining the presence of the number of the incoming call in the address book of said terminal.

7. A method according to claim 1, wherein in the event of the transfer of said incoming call to the selected favorite fixed communications terminal failing, the incoming call is transferred to the first fixed communications terminal or to another fixed communications terminal selected from among said plurality of fixed terminals.

8. A method according to claim 1, wherein the steps of selecting the favorite fixed communications terminal and of causing the call to be transferred are previously configured by the user executing a man/machine interface program stored in the local terminal attached to the local network.

9. A device for controlling the transfer of an incoming call made to a first fixed communications terminal situated in a local network towards a second fixed communications terminal forming part of a plurality of fixed communications terminals situated in said local network, the control device comprising:
comparison means for comparing firstly data about the incoming call and secondly call data associated with the fixed communications terminals of said plurality of fixed terminals and previously recorded in the local network, said call data associated with the fixed communications terminals of the plurality of fixed communications terminals being recorded beforehand in response to a discovery request made to those terminals and transmitted over the local network, said discovery request being sent from a local terminal situated in the local network, said request complying with a communications protocol appropriate for said local terminal and for said fixed communications terminals;
selection means for selecting as the second fixed communications terminal a favorite fixed communications terminal in application of a similarity criterion between the call data associated therewith and the data about the incoming call, said call data associated therewith being selected from at least incoming call data, outgoing call data, and address book data of said discovered fixed communications terminal; and
command means for causing said incoming call to be transferred to the selected favorite fixed communications terminal.

10. The control device according to claim 9, further including memory means for previously storing said call data associated with any fixed communications terminals situated in the local network.

11. A system for transferring an incoming call made to a first fixed communications terminal situated in a local network towards a second fixed communications terminal forming part of a plurality of fixed communications terminals situated in said local network, said system comprising:
the first fixed terminal, which includes message transmission means for using a communications protocol adapted to said first fixed terminal to transmit over the local network a message containing data of an incoming call received by said first fixed terminal;
a control device for controlling transfer of said incoming call, which comprises:
reception means for receiving said transmitted message in said communications protocol;
comparison means for comparing firstly data about the incoming call and secondly call data associated with the fixed communications terminals of said plurality of terminals and previously recorded in the local network, said call data associated with the fixed communications terminals of the plurality of fixed communications terminals being recorded beforehand in response to a discovery request made to those terminals and transmitted over the local network, said discovery request being sent from a local terminal situated in the local network, said request complying with a communications protocol appropriate for said local terminal and for said fixed communications terminals;
selection means for selecting as second fixed communications terminal a favorite fixed communications terminal in application of a similarity criterion between the call data associated therewith and the data about the incoming call, said call data associated therewith being selected from at least incoming call data, outgoing call data, and address book data of said discovered fixed communications terminal; and
sender means for sending a command to said first fixed terminal using said communications protocol to transfer said incoming call to the call number of said selected fixed communications terminal;
said first fixed terminal further comprising:
receiver means for receiving said transfer command sent using said communications protocol; and
received command processor means for:
extracting the call number of the selected fixed communications terminal; and
redirecting the incoming call to the selected fixed communications terminal associated with said extracted call number.

12. (canceled)

13. A non-transitory computer readable recording medium having recorded thereon a computer program including instructions for executing steps of a call transfer method of transferring an incoming call made to a fixed communications terminal situated in a local network, towards a second fixed communications terminal forming part of a plurality of fixed communications terminals situated in said local network, when said program is executed by a computer, wherein the instructions comprise:
instructions configured to cause the computer to make comparisons between firstly data about the incoming call and secondly call data associated with said fixed communications terminals of said plurality of terminals and previously recorded in the local network, said call data associated with the fixed communications terminals of the plurality of fixed communications terminals being recorded beforehand in response to a discovery request made to those terminals and transmitted over the local network, said discovery request being sent from a local terminal situated in the local network, said request complying with a communications protocol appropriate for said local terminal and for said fixed communications terminals;
instructions configured to cause the computer to select, as the second fixed communications terminal, a favorite fixed communications terminal in application of a similarity criterion between the call data associated with that terminal and the data about the incoming call, said call data associated therewith being selected from at least incoming call data, outgoing call data, and address book data of said discovered fixed communications terminal; and
instructions configured to cause the computer to cause said incoming call to be transferred to the selected favorite fixed communications terminal.
